(19) United States
(12) Patent Application Publication
(10) Pub. No.: US 2008/0110997 A1
(43) Pub. Date: May 15, 2008

(54) Flat mailable three-dimensional holder

(76) Inventor: Simon Phillips, York (GB)

Correspondence Address: BUCKLEY, MASCHOFF & TALWALKAR LLC, 50 LOCUST AVENUE, NEW CANAAN, CT, 06840, US

(21) Appl. No.: 11/585,499

(22) Filed: Oct. 24, 2006

(51) Int. Cl. G06K 19/06

(52) U.S. Cl. 235/492

(57) ABSTRACT

A flat mailable subcard holder is disclosed which, in some embodiments, includes a first planar portion having a top surface and a bottom surface, wherein the top surface defines a first portion of a recess, a second planar portion having a top surface and a bottom surface, wherein the top surface defines a second portion of a recess, and a hinge area, wherein the hinge area couples the first planar portion to the second planar portion, and wherein the first portion of the recess and the second half of the recess are to form a container sized to hold a subcard when the first planar portion is to be folded onto the second planar portion.

### BACKGROUND

A typical data card issuance process involves a data card issuer personalizing a card for a cardholder (a used herein, a “customer”) and then “fulfilling” the card by mailing the card to the customer. As used herein, a “data card” may be a payment card such as a credit card, debit card, smart card, or other card that may be personalized and issued to a customer. In a typical fulfillment process, the data card is mass-distributed from fulfillment centers after the card has been personalized for issuance to a cardholder. Cards are generally mailed to customers after each card has been embossed or otherwise personalized for individual customers. To minimize manufacturing and distribution costs, cards are typically mailed in standard business envelopes.

Some data cards may be used with holders or cases. For example, “contactless” payment cards such as MasterCard® PayPass® cards allow cardholders to make a purchase by simply tapping the payment card on a point-of-sale device. Many PayPass cardholders prefer to carry their PayPass cards on their keychain or in a protective carrying case. The protective cover helps protect the data card and also is shaped to make it easier for a cardholder to hold, carry and use the card.

While the data card itself may be easily and inexpensively mass distributed to a large number of cardholders, mass-distributing a protective cover is not as easy or inexpensive.

### BRIEF DESCRIPTION OF THE DRAWINGS

FIG. 1 is a diagram of an apparatus according to some embodiments.

FIG. 2 is a diagram of an apparatus according to some embodiments.

FIG. 3 is a diagram of an apparatus according to some embodiments.

FIG. 4 is a block diagram of a method according to some embodiments.

FIG. 6 is a diagram of a system according to some embodiments.

FIG. 5 is a diagram of an apparatus according to some embodiments.

FIG. 7 is a diagram of an apparatus according to some embodiments.

FIG. 8 is a diagram of an apparatus according to some embodiments.

FIG. 9 is a diagram of an apparatus according to some embodiments.

FIG. 10 is a diagram of an apparatus according to some embodiments.

### DETAILED DESCRIPTION

The several embodiments described herein are solely for the purpose of illustration. Embodiments may include any currently or hereafter-known versions of the elements described herein. Therefore, persons in the art will recognize from this description that other embodiments may be practiced with various modifications and alterations.

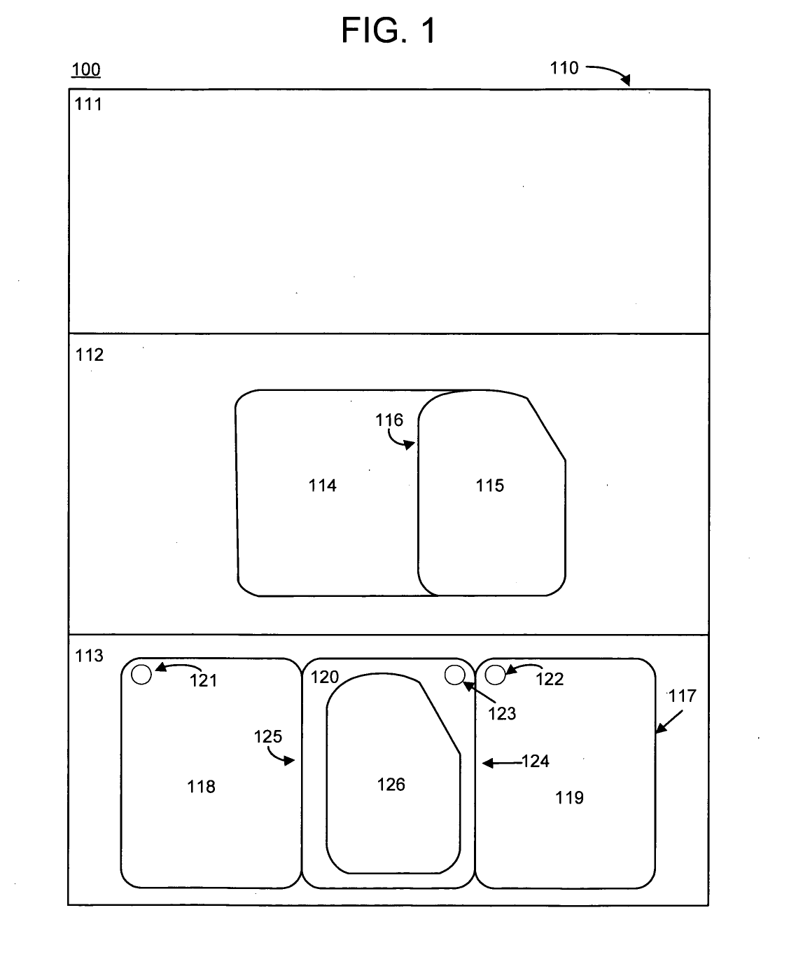

Referring to FIG. 1, an embodiment of mailing kit 100 is shown. The mailing kit 100 may comprise a backing 110, a subcard 115 having a subcard attachment 114, and a foldable card holder 117. The backing 110 may be folded into one or more sections 111, 112, 113. The backing 110 may comprise, but is not limited to, card stock, cardboard, paper, or plastic. As illustrated in FIG. 1, the backing 110 may have a first section 111, a second section 112, and a third section 113. The first section 111 may include printed or embossed information associated with a customer such as, but not limited to, address information, customer information, instructions, or other information. The backing 110, when folded, may be sized to fit into a mailer. The mailer may comprise, but is not limited to, an envelope, a bag, a box, or any suitable packaging. The subcard 115 and the subcard attachment 114 may be removably attached to a section 111, 112, 113 of the backing.

The subcard attachment 114 and the subcard 115 are, in some embodiments, manufactured as a single card (e.g., such as a card sized and formatted in compliance with ISO Standard 7816) using existing card manufacturing processes. The subcard 115 portion of the card may be detached from the subcard attachment 114 portion of the card at a crease 116 or seam. In some embodiments, the crease 116 may be a scored edge. For example, when a customer receives the mailer, both the subcard attachment 114 and the subcard 115 are removed from the mailer and the customer can detach the subcard 115 from the subcard attachment 114 by bending or cutting at the crease 116. In some embodiments, the crease 116 is a perforated or scored line that makes it easy for a customer to detach the subcard 115 from the subcard attachment 114. The subcard attachment 114 may include printed or embossed information such as, but not limited to, address information, customer information, instructions, or other information.

The subcard 115 may include printed or embossed information such as, but not limited to, a customer's name, an account number, an expiration date, a “member since” date, a logo, or a trademark. The subcard 115 may also include a chip and an antenna. In some embodiments the chip may be coupled to the antenna and the chip. In some embodiments, the subcard 115 may be about 54 millimeters at its longest point and about 30 millimeters at its widest point. In some embodiments, the subcard 115 may be about 0.68 millimeters thick. In some embodiments, the subcard 115 may be about 54 millimeters at its longest point and about 18 millimeters at its widest point. In some embodiments, the data card may be a contactless card.

The foldable card holder 117 may be removably attached to a section 111, 112, 113. The foldable card holder 117 may comprise a first portion 118, a second portion 120, and a third portion 119. The first portion may comprise a first key ring hole 121 and the third portion 119 may comprise a second key ring hole 122. The second portion 120 may include a third key ring hole 123 and a recessed area 126 below the planar surface of the third portion 119 to house the subcard 115.

The first portion 118 may be coupled to the second portion 120 at a crease 125 and the second portion 120 may be coupled to the third portion 119 by a second crease 124. In some embodiments, the crease 125 may be flexible, allowing the first portion 118 to fold onto the second portion 120 and the crease 124 may be flexible, allowing the third portion 119 to fold onto the second portion 120. When folded, the first key ring hole 121 may be aligned with the second key ring hole 122 and the third key ring hole 123 such that a key ring may pass through the first key ring hole 121, the second key ring hole 122, and the third key ring hole 123. In some embodiments, when folded, the first portion 118 the second portion 120, and the third portion 119 may be about 5.4 millimeters thick.

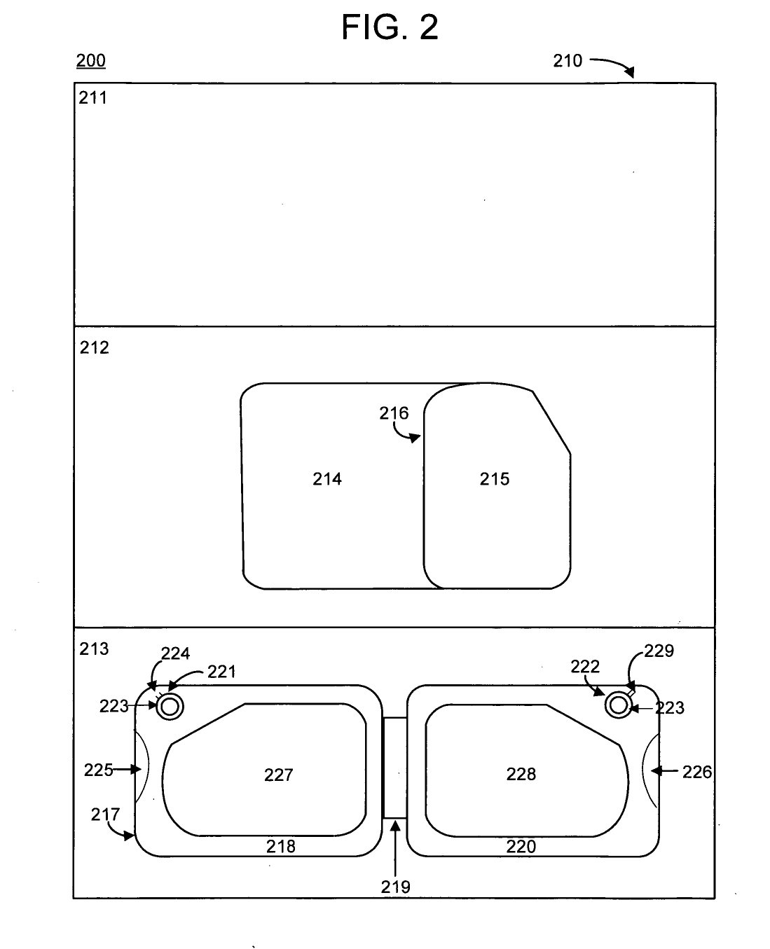

Now Referring to FIG. 2, an embodiment of a mailing kit 200 is shown. The mailing kit 200 may comprise a backing 210, a subcard 215 removably coupled to a subcard attachment 214 by a crease 216 (or scored or perforated line), and a foldable card holder 217. The backing 210, the subcard 215, and the subcard attachment 214 may be as described with respect to FIG. 1.

The foldable card holder 217 may comprise a first portion 218, and a second portion 220. In some embodiments, the fist portion 218 and the second portion 220 may be planar. The first portion may comprise a first key ring hole 221, a first feed gate 224, a first rubber ring 223 within the first key ring hole 221 and a first recess 225. The second portion may comprise a second key ring hole 222, a second feed gate 229, a second rubber ring 223 within the second key ring hole 222 and a second recess 226. In some embodiments, the first recess 225 and the second recess may be used to open the foldable card holder 217. For example, when folded, the first recess 225 and the second recess 226 may combine to form a recess capable of partially holding an inserted object, such as, but not limited to, a coin. Twisting the object when inserted into the recess 225, 226, or using the object as a lever, may separate the first portion 218 from the second portion 220.

The first portion 218 may have a first recessed area 227 and the second portion may have a second recessed area 228. The first recessed area 227 when folded onto the second recessed area 228 may form a container to house the subcard 215 and in some embodiments may be about 5.4 millimeters thick.

The first portion 218 may be coupled to the second portion 220 by a hinge 219. The hinge 219 may be flexible, allowing the first portion 218 to fold onto the second portion 220. In some embodiments, the hinge 219 may be rigid and when folded may act as a rigid fastener or locking hinge between the first portion 218 and the second portion 220. In some embodiments, when the first portion 218 is folded onto the second portion 220, the first key ring 221 may align with the second key ring 222, the first feed gate 224 may align with the second feed gate 229, and the first recessed area 227 may align with the second recessed area 228. In some embodiments, when the first key ring hole 221 is aligned with the second key ring hole 222 a key ring may be passed between through the first feed gate 224 and the second feed gate 229. In some embodiments, the first portion 218 may be about 61.47 millimeters at a longest point and about 37.47 millimeters at a widest point.

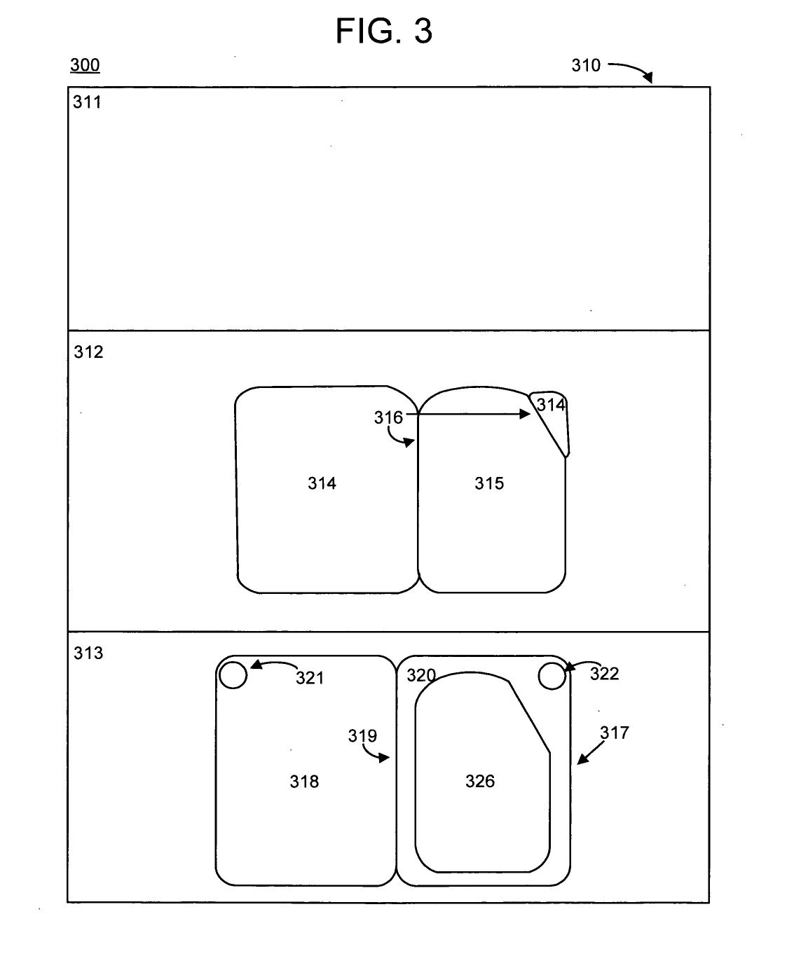

Referring to FIG. 3, an embodiment of a mailing kit 300 is shown. The mailing kit 300 may comprise a backing 310, a subcard 315 having removably coupled to one or more subcard attachments 314 by one or more creases 316 (or scored or perforated line), and a foldable card holder 317. The backing 310, the subcard 315, and the one or more subcard attachments 314 may be as described with respect to FIG. 1.

The foldable card holder 317 may comprise a first portion 318, and a second portion 320. The first portion 318 may include a first key ring hole 321 and the second portion may contain a second key ring hole 322 and a recessed area 326 below the planar surface of the second portion 320 to house the subcard 315.

The first portion 318 may be coupled to the second portion 320 by a crease 319. In some embodiments, the crease 319 may be flexible, allowing the first portion 318 to fold onto the second portion 320. In some embodiments, when the first portion 318 is folded onto the second portion 320, the first key ring hole 321 may be aligned with second key ring hole 322 such that a key ring may pass through the first key ring hole 321 and the second key ring hole 322. In some embodiments, when folded, the first portion 318 and the second portion 320 may be about 5.4 millimeters thick.

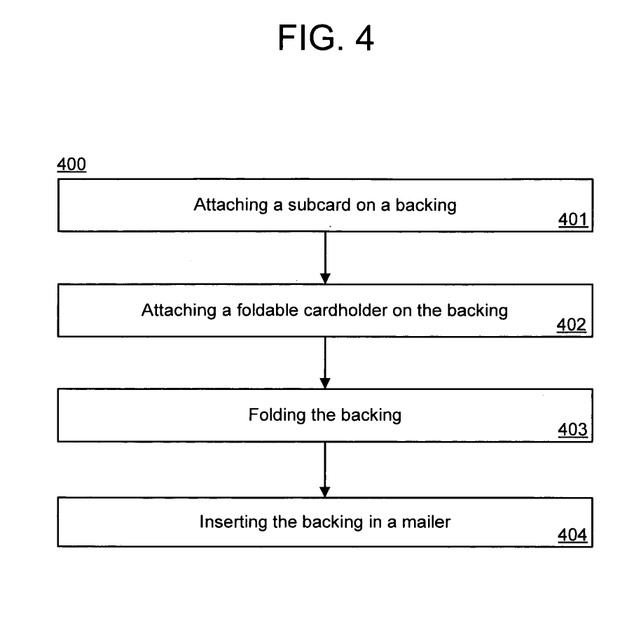

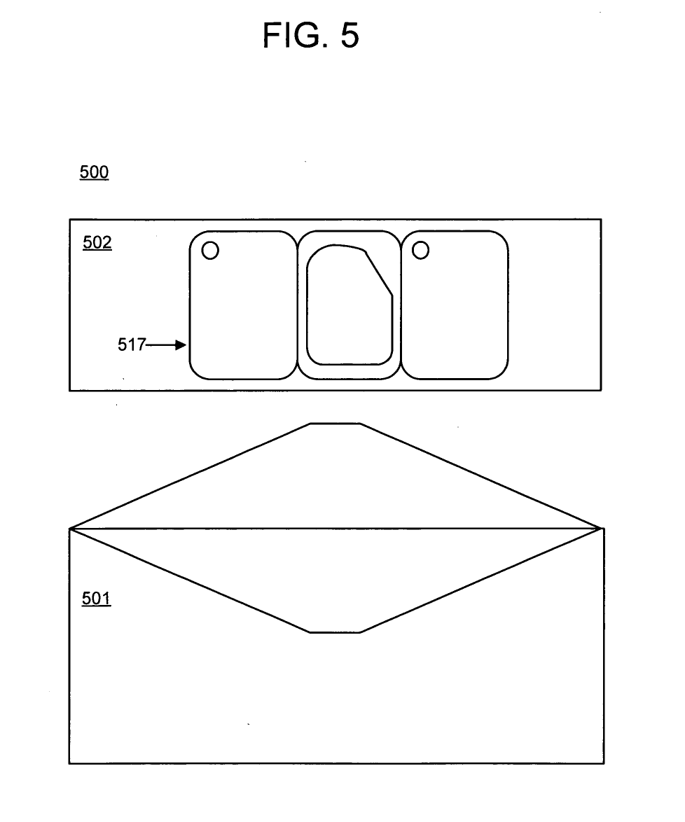

FIG. 4 shows an embodiment of a method 400. At 401, a subcard such as, but not limited to, the subcard described in FIG. 1 may be removably attached to a backing. The backing may comprise, but is not limited to, card stock, cardboard, paper, or plastic and the subcard may be removably attached using any available means, such as, but not limited to, glue, rubber cement, wax, and plastic.

At 402, a foldable card holder may be removably attached to the backing. The foldable card holder may be any card holder such as, but not limited to, the foldable card holders of mailing kit 100, 200, or 300. The foldable card holder may be removably attached to the backing using any available means, such as, but not limited to, glue, rubber cement, wax, plastic cement, and plastic.

The backing is folded at 403. The backing may be folded in any configuration that allows the backing, the removably attached subcard, and the removably attached foldable card holder to fit in a mailer such as, but is not limited to, an envelope, a bag, a box, or any suitable packaging.

At 404, the backing may be inserted into a mailer. In some embodiments, the subcard and the foldable card holder may be removably attached to the backing when the backing is inserted into the mailer.

Now referring to FIG. 5, an embodiment of a system is shown. The system 500 may implement process 400 according to some embodiments. The system may comprise a backing 502 and a mailer 501 to hold the backing 502. The backing 502 may be as described with respect to FIG. 1 and the mailer 501 may be, but is not limited to, an envelope, a bag, a box, or any known or hereafter known packaging.

The backing 502 may be folded such that it may be contained within the mailer 501. In some embodiments, the mailer containing the backing 502 may be about 5.4 millimeters thick.

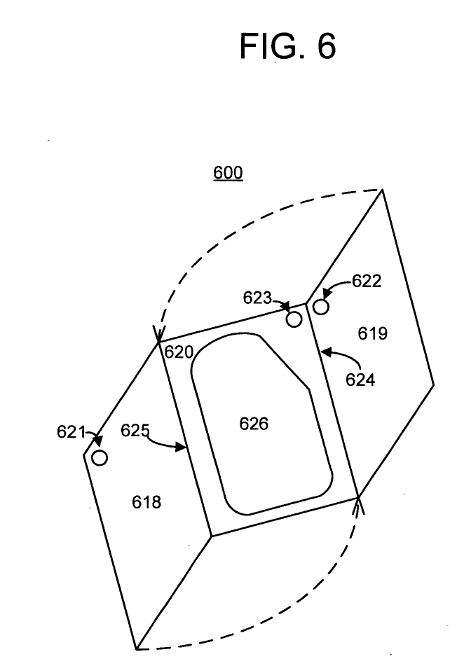

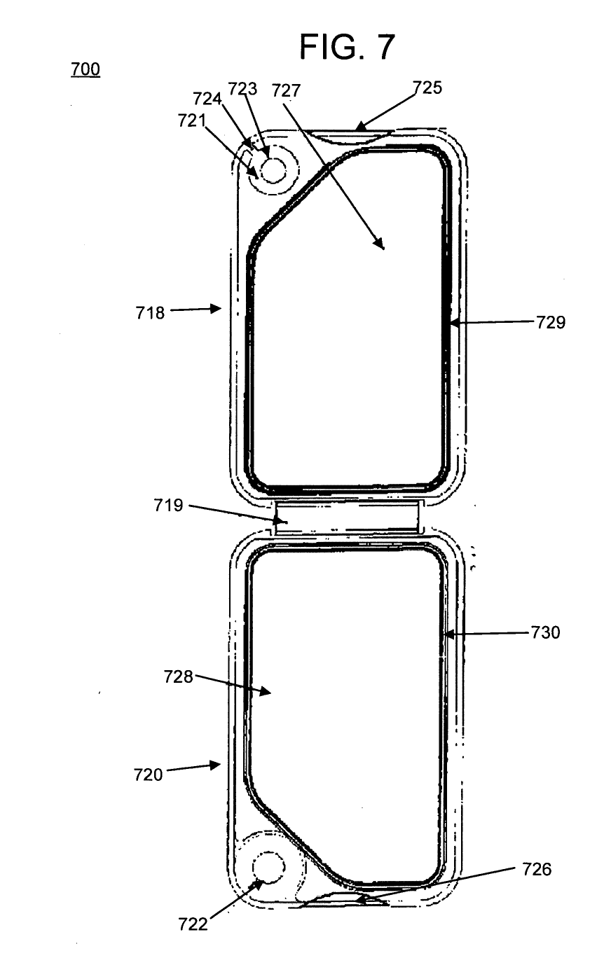

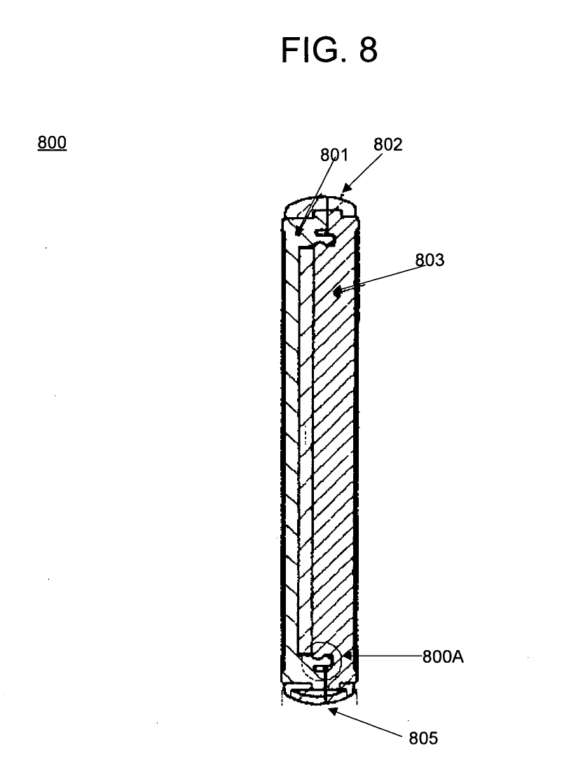

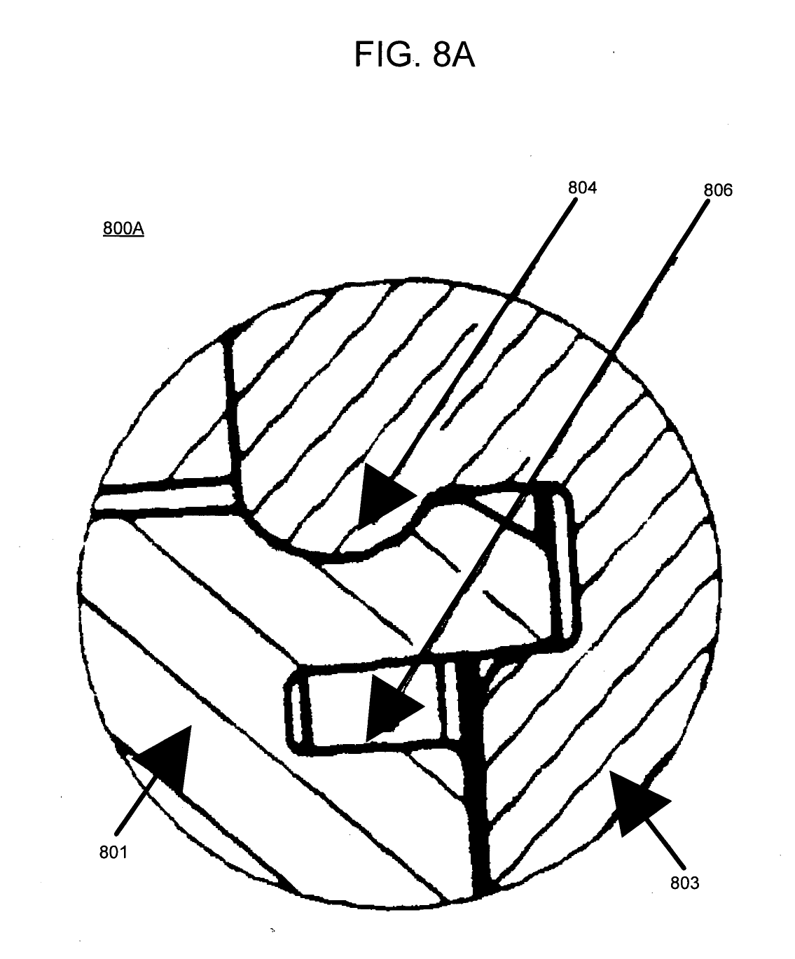

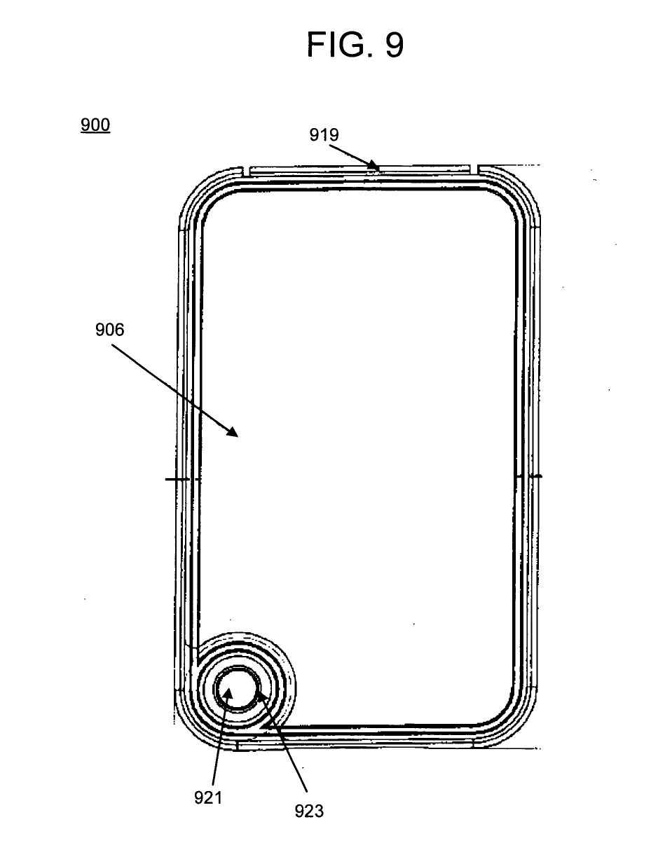

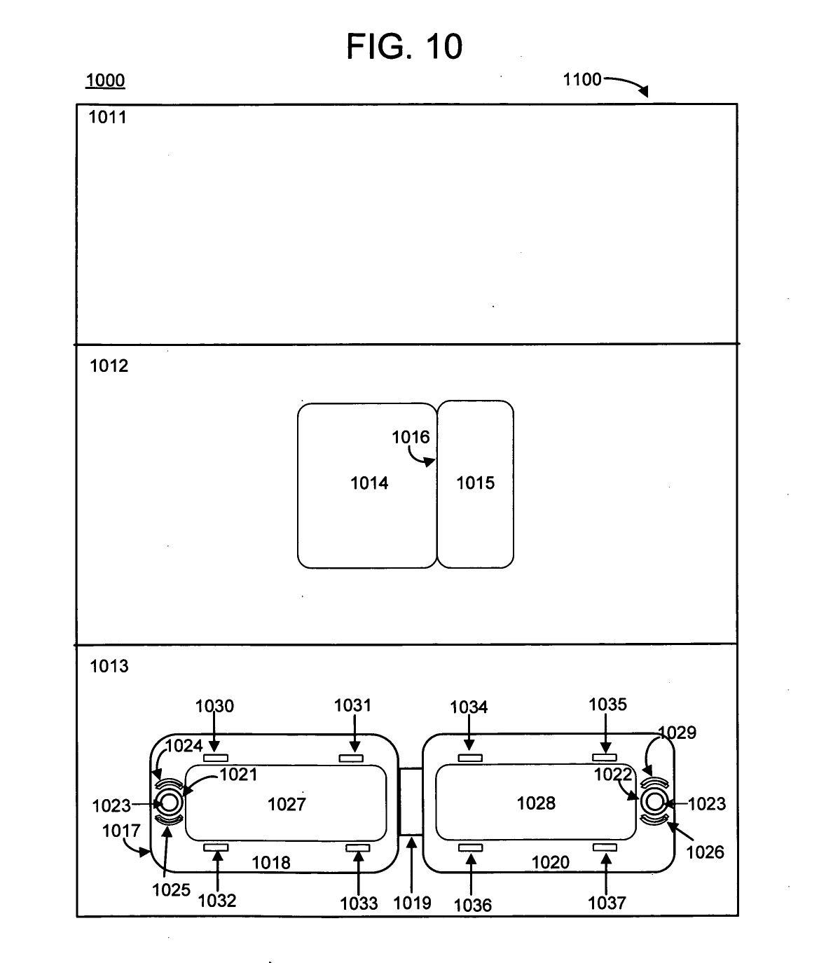

Now referring to FIG. 6, an embodiment of a foldable card holder 600 is shown. In some embodiments, the foldable card holder 600 may comprise a first portion 618, a second portion 620, and a third portion 619. The first portion may comprise a first key ring hole 621. The third portion 619 may comprise a second key ring hole 622. The second portion 620 may contain a third key ring hole 623 and a recessed area 626 below the planar surface of the second portion 620 to house a subcard. A fist crease 625 may couple the first portion 618 to the second portion 620 and a second crease 624 may couple the third portion to the second portion. In some embodiments, the first crease 625 may be flexible, allowing the first portion 618 to fold onto the second portion 620. In some embodiments, the second crease 624 may be flexible, allowing the third portion 619 to fold onto the second portion 620. In one embodiment, when folded in a manner as shown in FIG. 6, the first key ring hole 621 may be aligned with second key ring hole 622 and the third key ring hole 623 such that a key ring may pass through the first key ring hole 621, the second key ring hole 622, and the third key ring hole 623.

Now referring to FIG. 7, an embodiment of an apparatus 700 is shown. In some embodiments, the apparatus 700 may be a foldable card holder. The apparatus 700 may comprise a first portion 718, and a second portion 720. The first portion may comprise a first key ring hole 721, a first feed gate 724, a first rubber ring 723 within the first key ring hole 721, a first seal 729, and a first recess 725. The second portion may comprise a second key ring hole 722, a second seal 730, and a second recess 726.

The first portion 718 may have a first recessed area 727 and the second portion may have a second recessed area 728. The first recessed area 227 when folded onto the second recessed area 728 may house a subcard and in some embodiments may be about 5.4 millimeters thick.

The first portion 718 may be coupled to the second portion 720 by a hinge 719. The hinge 719 may be flexible, allowing the first portion 718 to fold onto the second portion 720. In some embodiments, the hinge 719 may be rigid and when folded may act as a rigid fastener between the first portion 718 and the second portion 720. When folded, the first key ring hole 721 may align with the second key ring hole 722 and the first recessed area 727 may align with the second recessed area 728. In some embodiments, when a the first key ring 721 is aligned with the second key ring 722 the rubber ring 723 may create a seal between the first key ring hole 721 and the second key ring hole 722 to prevent liquid or debris from entering the foldable card holder.

The first seal 729 and the second seal 730 may couple the first portion 718 to the second portion 720. The first seal 729 may comprise a snap, a flexible lip, or a dovetail such that it may be coupled with a corresponding snap, flexible lip, or dovetail of the second seal 730.

Now referring to FIG. 8, a side view of an apparatus 800 is shown. The apparatus 800 may comprise a first portion 801, an overmold 802, a second portion 803, one or more locking mechanisms 800A, and a hinge 805. The hinge 805 may comprise, but is not limited to, rubber or plastic. The hinge 805 may allow the first portion 801 to fold onto the second portion. The first portion 801 may be coupled to the second portion 803 by the locking mechanism 800A and the overmold 802.

Now referring to FIG. 8A, an embodiment of a locking mechanism 800A is shown. The locking mechanism 800A may comprise a locking feature 804 and a guide 805. The guide 805 may align first portion 801 with second portion 802 such that the locking feature 804 may couple first portion 801 to the second portion 803. In one embodiment the locking mechanism 804 may couple first portion 801 with second portion 803 by inserting a convex piece of the first portion 801 into a concave piece of the second portion 802. The locking mechanism 800A may not extend past a bottom surface of the first portion 801 or the second portion 802.

Now referring to FIG. 9, a side view of an apparatus 900 is shown. The apparatus 900 may comprise a hinge 919, a key ring 921, a rubber ring 923 and an outside surface 906. The hinge 919 may comprise, but is not limited to, a rubber or plastic. The outside surface may be a highly polished finished material such as, but not limited to, metal, plastic, colored polypropylene, and clear polypropylene.

Now Referring to FIG. 10, an embodiment of a mailing kit 1000 is shown. The mailing kit 1000 may comprise a backing 1010, a subcard 1015 removably coupled to a subcard attachment 1014 by a crease 1016, and a foldable card holder 1017. The backing 1010, the subcard 1015, and the subcard attachment 1014 may be as described with respect to FIG. 1.

The foldable card holder 1017 may comprise a first portion 1018, and a second portion 1020. In some embodiments, the fist portion 1018 and the second portion 1020 may be planar. The first portion 1018 may comprise a first key ring hole 1021, a first connector 1024, a second connector 1025, a first tab 1030, a second tab 1031, a third tab 1032, a fourth tab 1033 and a first rubber ring 1023 within the first key ring hole 1021.

The second portion 1020 may comprise a second key ring hole 1022, a third connector 1029, a fourth connector 1026, a fifth tab 1034, a sixth tab 1035, a seventh tab 1036, an eighth tab 1037 and a second rubber ring 1023 within the second key ring hole 1022.

In some embodiments, the plurality of connectors 1024/1025/1026/1029 and the plurality of tabs 1030-1037 may couple the first portion to the second portion. For example, when folded, the first connector 1024 and the third connector may interlock such that the first portion 1018 and the second portion 1020 may be coupled. In a similar fashion, the second connector 1025 may interlock with the fourth connector 1026, the first tab 1030 may interlock with the fifth tab 1034, the second tab 1031 may interlock with the sixth tab 1035, the third tab 1032 may interlock with the seventh tab 1036, and the fourth 1033 tab may interlock with the eighth tab 1037. In some embodiments, the distance between the first tab 1030 and the fourth tab 1032 may be about 18 millimeters.

The first portion 1018 may have a first recessed area 1027 and the second portion may have a second recessed area 1028. The first recessed area 1027 when folded onto the second recessed area 1028 may form a container to house the subcard 1015 and in some embodiments may be about 5.4 millimeters thick. The first portion 1018 may be coupled to the second portion 1020 by a hinge 1019. The hinge 1019 may be flexible, allowing the first portion 1018 to fold onto the second portion 1020. In some embodiments, the hinge 1019 may be rigid and when folded may act as a rigid fastener or locking hinge between the first portion 1018 and the second portion 1020.

Various modifications and changes may be made to the foregoing embodiments without departing from the broader spirit and scope set forth in the appended claims.

What is claimed is:

1. An apparatus comprising:
a first planar portion having a top surface and a bottom surface, wherein the top surface defines a first portion of a recess;
a second planar portion having a top surface and a bottom surface, wherein the top surface defines a second portion of a recess; and
a hinge area, wherein the hinge area couples the first planar portion to the second planar portion, and
wherein the first portion of the recess and the second half of the recess are to form a container sized to hold a subcard when the first planar portion is to be folded onto the second planar portion.

2. The apparatus of claim 1, further comprising:
a feed gate;
a key ring hole; and
a rubber ring within the key ring hole.

3. The apparatus of claim 1, wherein the bottom surface of the first planar portion and the bottom surface of the second planar portion have a highly polished finish.

4. The apparatus of claim 1, wherein the first planar portion and the second planar portion are composed of clear polypropylene.

5. The apparatus of claim 1, further comprising:
a locking mechanism, wherein the locking mechanism does not extend past the bottom surface of the first planar portion and does not extend past the bottom surface of the second planar portion.

6. The apparatus of claim 1, wherein the hinge area is rubber.

7. The apparatus of claim 1, wherein the bottom surface of the first planar portion and the bottom surface of the second planar portion are removably attached to a backing.

8. The apparatus of claim 7, wherein the backing is a card stock.

9. The apparatus of claim 8, wherein the backing is to be folded and is sized to be inserted into a mailer.

10. The apparatus of claim 1, wherein the subcard comprises:
a chip; and
an antenna.

11. The apparatus of claim 1, wherein the subcard is to be coupled between the first half of the recess and the second half of the recess.

12. The apparatus of claim 1, wherein the dimensions of the first planar portion are about 37.47 millimeters by about 61.47 millimeters.

13. The apparatus of claim 1, wherein the thickness of the first planar portion folded onto the second planar portion is about 5.4 millimeters.

14. An apparatus comprising:
a backing;
a mailer;
a subcard; and
a foldable card holder, wherein the subcard and the foldable card holder are removably attached to the backing, and
wherein the backing is to be inserted in the mailer.

15. The apparatus of claim 14, wherein the subcard is to be inserted in a first portion of the foldable card holder and is to be coupled between a second portion of the foldable card holder and a third portion of a foldable card holder.

16. The apparatus of claim 14, wherein the subcard is to be coupled between a first portion of the foldable card holder and a second portion of a foldable card holder.

17. The apparatus of claim 16, wherein the first portion of the foldable card holder is to be coupled to the second portion of the foldable card holder by at least one of the following: a snap, a flexible lip, a locking hinge, and a dovetail.

18. The apparatus of claim 14, wherein the mailer is an envelope.

19. The apparatus of claim 14, wherein the subcard is about 54 mm long at its longest point and about 30 mm wide at its widest point.

20. The apparatus of claim 14, wherein the subcard comprises:
a chip; and
an antenna.

21. The apparatus of claim 14, wherein the foldable card holder is polypropylene.

22. The apparatus of claim 14, wherein the foldable card holder further comprises a hole.

23. A method of manufacturing a foldable product comprising:
mounting a subcard to a backing;
mounting a foldable card holder to the backing;
folding the backing; and
inserting the backing in a mailer.

24. The method of claim 23, wherein the subcard is to be inserted in a first portion of the foldable card holder and is to be coupled between a second portion of the foldable card holder and a third portion of a foldable card holder.

25. The apparatus of claim 23, wherein the subcard is to be coupled between a first portion of the foldable card holder and a second portion of a foldable card holder.

26. The apparatus of claim 25, wherein the first portion of the foldable card holder is to be coupled to the second portion of the foldable card holder by at least one of the following: a snap, a flexible lip, a locking hinge, and a dovetail.

27. The apparatus of claim 23, wherein the mailer is an envelope.

28. The apparatus of claim 23, wherein the subcard is about 54 mm long at its longest point and about 30 mm wide at its widest point.

29. The apparatus of claim 23, wherein the subcard comprises an antenna.

30. The apparatus of claim 23, wherein the foldable card holder is polypropylene.

31. The apparatus of claim 23, wherein the foldable card holder comprises a hole.
